(19) United States
(12) Patent Application Publication
(10) Pub. No.: US 2016/0077026 A1
(43) Pub. Date: Mar. 17, 2016

(54) METHOD AND AN APPARATUS TO MEASURE FLOW PROPERTIES, INCLUDING FLOW RATES, REGIME AND RELATIVE CONCENTRATIONS OF PHASES IN MULTIPHASIC FLUIDS USING NUCLEAR MAGNETIC RESONANCE RELAXATION IN THE ROTATING FRAME

(71) Applicants: DANTE ANDRES PUSIOL, ALTA GRACIA (AR); JULIA INES GARCIA, CARLOS PAZ (AR)

(72) Inventors: DANTE ANDRES PUSIOL, ALTA GRACIA (AR); JULIA INES GARCIA, CARLOS PAZ (AR)

(73) Assignee: Spinlock srl, MALAGUENO (AR)

(21) Appl. No.: 14/855,369

(22) Filed: Sep. 15, 2015

Related U.S. Application Data
(60) Provisional application No. 62/051,281, filed on Sep. 16, 2014.

(51) Int. Cl. G01N 24/08; G01F 1/56

(52) U.S. Cl. CPC G01N 24/08; G01F 1/56

(57) ABSTRACT

Rotating frame magnetic resonance based method and apparatus to measure and analyze flow properties in flowing complex fluids. The method consists on: 1) polarizing NMR active spins in a magnetic field region, 2) relaxing the plurality of individual macroscopic magnetizations in a second magnetic field region, wherein a plurality of radiofrequency pulses are irradiating said phases of said multiphasic fluid, wherein phase individual rotating frame relaxation times weight magnetization of said individual phases at said downstream end, wherein a plurality of contrast degrees between respective magnetization of individual phases, 3) measuring the total macroscopic magnetization in a third magnetic field region on an NMR measurement segment, and 4) reading the multidimensional data matrix with a tangible computer readable medium. The apparatus consists on: 1) a first magnet with constant magnetic field intensity, 2) a second magnet with variable rotating-frame pulse sequences at a plurality of radiofrequency sequences, intensity and time, 3) a third magnet having radio frequency antennas and field gradient coils (NMR module), and 4) a computing digital processor.

### CROSS-REFERENCE TO RELATED APPLICATIONS

This application claims the benefits of Provisional Application 62/051,281 filed on Sep. 16, 2014.

### BACKGROUND OF THE INVENTION

1. Field of the Invention

This invention is related to nuclear magnetic resonance (NMR) instrumentation apparatus and method for use in flow regime analytical applications in multiphasic fluids. In particular, the invention relates generally to measurements of flow properties, such as rates, regime and/or relative concentrations in multiphasic fluids in a production and/or any other kind of fluid vein.

The invention also includes in-line measurements of bulk and/or localized physicochemical, rheological properties of the fluid and flowing fluid magnetic resonance images, as well. Both the method and the tool allow in particular measurement of the flow rates of individual components of the composed complex fluid, in a non-invasive and non-destructive way, and independently of the state of the mixture. The invention provides a wide range of Multiphasic Fluids to be studied, being composed by any mixtures of solids, liquids, gases, emulsions, foams and/or powdered solids. The mixtures can be homogeneous or not. Those non-homogeneous single or mixture materials are included at any sizes of drops and or grains, even those at micro and nano-metric scales as well.

The invention is preferably applied to the measurement of heterogeneous mixtures of petroleum, water and gas, as encountered in production lines, drilling fluids, and other types of transported single or multiphasic fluids.

The method and respective device carried out to materialize the present invention are distinguished as forming a Multiphasic Flow Meter, characterized by the lack of movable parts and strong magnetic fields that vary with time.

2. Description of the Previous Art

Since at least as early as the 1960s, Magnetic Resonance (NMR) for use in flow measurements, dedicated flow meters, and various analytical measurements on fluids has been extensively investigated, including several variations in apparatus and methods of implementation, (see, for example, U.S. Pat. No. 3,419,795, issued to Genthe et al.).

There are a number of potential advantages of fluid flow measurement by NMR, including the following: (i) NMR does not require disturbing flow of the fluid; (ii) NMR does not require creation of a pressure drop in the flowing fluid; (iii) No instruments or sensors have to be exposed to the flowing fluid other than the inside surface of the flow channel. Therefore, deleterious effects on flow, accuracy, and flow sensor components due to deposits, clogging, abrasion, and fouling by corrosive, abrasive, viscous, or biphasic fluids such as slurries can be avoided.

In general, NMR flow meters work on variations of the concept of applying a radio frequency (RF) field to a flow of materials that have a nuclear magnetic moment, usually from an odd number of protons in their atomic structure, for example, hydrogen, fluorine, chlorine, and others, to sense resonance interaction between an externally applied magnetic field and the magnetic moments of the flowing material. Since hydrogen has a large nuclear magnetic moment and is present in high number densities in nearly all fluids, NMR flow meters should be particularly well-suited to hydrogenous materials, including water, hydrocarbons, and many others. Most schemes for measuring flow with NMR principles can be categorized loosely into several groupings, including relaxation methods, time-of-flight methods, and field gradient methods.

The foregoing examples of related art and limitations related therewith are intended to be illustrative and not exclusive, and they do not imply any limitations on the inventions described herein. Other limitations of the related art will become apparent to those skilled in the art upon a reading of the specification and a study of the drawings.

The previous art illustrates on several methods to contrast in flow the respective cuts of oil, water and gas. They are mainly based in the NMR signal intensities contrasted by their respective Spin-Lattice Relaxation Time (T₁). The fluid flow through a first stage where protons are polarized, in a second steps fluid velocity and composition is analyzed. As an example, the U.S. Pat. No. 6,268,727 B1, “Measurements of flow fractions flow velocities and flow rates of a multiphase fluid using ESR sensing” issued to J. D. King, et al., illustrates on a method and an apparatus which exploit a combination of NMR and ESR (Electron Spin Resonance) to measure the fluid multiphase composition and the molecules time of flight between two spectrometers to measure the respective fluid phase velocities. The methodology assumes necessarily a homogeneous mixture of phases in the fluid, which is a serious practical limitation in the oil & gas applications. U.S. Pat. No. 6,452,390 “Magnetic Resonance analyzing flow meter and flow measuring method”, granted to E. Wollin, employs periodic magnetic field map flow velocity in non-uniform velocity profile. The method and its respective apparatus is not claimed to be useful to analyzing multiphasic fluid.

The U.S. Pat. No. 7,719,267, “Apparatus and method for real time and real flow-rates measurements of oil and water cuts from oil production”, issued to D. J. Pusiol and the U.S. Pat. No. 7,872,474, “Magnetic resonance based apparatus and method to analyze and to measure the bi-directional flow regime in a transport or a production conduit of complex fluids, in real time and real flow-rate”, by D. J. Pusiol, et al., illustrate on methods and their respective apparatus for multiphase flow meter and individual flow regime characterization, including in-pipe Magnetic Resonance Imaging. The contrast between phases is reached in the pre-polarization section of the apparatus. During the fluid-proton nuclei polarization process, the effective length of that magnet is changed, allowing first polarize nuclei possessing short spin-lattice relaxation time, T₁, and then, when the pre-polarizing magnetic field segment is settled the longest necessary to completely prepolarize all proton nuclei of the multiphasic fluid. Different pre-polarization lengths then weight NMR signals from protons of molecules of different phases, acquired at the NMR segment of the apparatus.

The U.S. Provisional Patent Application No. 62/051,287, filed Sep. 16, 2014, discloses a method, which is materialized in a device that does not use movable parts to measure the relative flow rates of the chemical components of multiphasic fluids. The invention is based on the Field Cycling NMR Principle (see Duarte Mesquita Sousa, et al., Desktop fast field cycling nuclear magnetic resonance relaxometer, Solid State Nuclear Magnetic Resonance, 38 (2010) 36-43). The methodology is developed in at least three steps: i) at upstream, spins of all molecules of the fluid are fully polarized; ii) a second relaxation step where the previously polarized spins relaxes at a variable magnetic field follows downstream; iii) at the third downstream segment, magnetic resonance time domain relaxometry and/or diffusometry parameters are measured and/or imaged. Mathematical algorithms relate, in the fourth step, those NMR data to the said flow, physicochemical, rheological properties of the multiphasic fluid, including their in-vein spatial localization by MRI. In the second relaxation segment, NMR signal amplitudes of the fluid phases relax at different rates. Therefore, at the second relaxation segment, each individual contribution of the total signal which will be measured. When the multiphasic fluid reaches the measurement segment, depending of the length and/or strength of the magnitude of the relaxation field, each fluid-phase contributes different to the total NMR signal amplitude. In the said third step spins of the sample are subjected to radiofrequency and magnetic field gradient steady state and/or pulsed sequences designed ad-hoc for each measurement. Those magnetic resonance parameters could also be cyclically measured at several values of the relaxation magnetic field in such a way that the sample relaxation and/or diffusion profiles can be scanned and storage in a mathematical multidimensional data matrix.

The main restriction in the applicability of the Field Cycling NMR Multiphasic Flow Meter lies in the necessary isolation of the electromagnet -which provides the so-called magnetic field driving the second relaxation flow meter segment- and the NMR magnet, at the third step. In spite of different tricks that could implement to avoid changes in the value and/or homogeneity of the Zeeman magnetic field at the third step, a physical separation in between both magnets is unavoidable. So, during the passage of the fluid through the portion of the pipe between the pipe's volume where the relaxation process takes place and the measurement volume, some part of the relaxed longitudinal magnetization should be uncontrolled recovered. That effect is particularly undesirably in low velocity fluids and/or short spin-lattice relaxation time fluids.

The invention disclosed herein differs fundamentally from previous approaches because: i) the contrast between phases is achieved by their individual phase relaxation in the rotating frame, instead of achieving it on the relaxation in zero-field as previously disclosed; ii) there is no variable magnetic field applied, therefore no electro magnet or other strong pulsed magnetic field device in any step of the measurement procedure, therefore the multiphasic fluid always runs in a timely constant magnetic field; and iii) its practical materialization implies inexistence of moving parts in the flow meter.

The present invention discloses a methodology based on the phenomena of relaxation in the rotating frame to reach a contrast in the NMR signals of the phases composing said multiphasic fluid. The methodology can be used in combination with other contrast and/or measurements techniques involving Magnetic Resonance in flowing materials: Field Cycling of both Nuclear Magnetic Resonance, NMR, Electron Paramagnetic Resonance, EPR, Electron Spin Resonance, ESR, Nuclear Quadrupole Resonance, NQR, and any combination of them (also known as Double or Higher Order Resonances) methodology and its respective apparatus.

### BRIEF SUMMARY OF THE INVENTION

The present invention discloses a method and apparatus of Nuclear Magnetic Resonance in the rotating frame to measure flow, evaluate flow regime, physicochemical and rheological properties of a multiphasic complex fluid, while said multiphasic fluid is flowing through a vein having unknown geometry and mixture states. The disclosed method involves applying to the multiphasic flow at least four segments: i) a pre-polarization segment consisting of a magnetic field that polarizes spins of the multiphasic fluid with the spin-lattice relaxation time (T1); ii) a first NMR segment comprising a rotating frame relaxation segment which weights the magnetization of the individual phases of the multiphasic fluid at corresponding contrast states; iii) a second NMR segment, wherein NMR signals acquired at different contrast degrees are measured, composing a multidimensional matrix of data containing information of said multiphasic fluid and flow regime; and iv) in a fourth segment, a processor configured to evaluate flow regime, physicochemical and rheological properties of the multiphasic fluid, while said multiphasic fluid is flowing through a vein having arbitrary geometry and mixture states.

### BRIEF DESCRIPTION OF DRAWINGS

Further features and applications of the present invention will become readily apparent from the figures and detailed description that follows. The present disclosure is best understood with reference to the following figures in which like numerals refer to like elements, and in which:

FIG. 1: Illustrates on measurements of Larmor frequency behavior of T₁ (filled circles and squares) T₁_{_{ρ}} (open circles and squares) on, respectively, three phases: gas, brine, light and heavy oils. Spin-lattice relaxation weighted contrast by conventional 25, low frequency field cycling 35 and rotating frame 45, are compared as well.

FIG. 2: Illustrates on a general schematic representation of a multiphase flow meter/analyzer/controller. The apparatus 10 possesses four segments; each one processes specific actions on said multiphasic fluid stream. They are identified from up to downstream: i) a NMR active multiphasic fluid molecular nuclear spins prepolarization 11; ii) contrast magnetization of phases by rotating frame relaxation mechanisms 12; iii) a conventional NMR—MRI module 13, which generate a plurality of data matrixes; and iv) a plurality of processors 14 to evaluate said data matrixes and to display results.

FIG. 3: Illustrates on one preferred embodiment of the invention. The four segments of the apparatus are illustrated: i) a first pre-polarization permanent magnet; ii) a second contrast segment, where the sample relaxes under frequency, phase and intensity variable radiofrequency magnetic field; iii) a third segment, the NMR-module, including MRI gradients, where the NMR parameters are measured; and iv) a processor where data matrix, built in the previous third segment, is processed and results displayed.

FIG. 4a: Illustrates a generalized self-compensated pulse sequence for T₁-weighted contrast in the preferred embodiment shown in FIG. 3. Each radiofrequency pulse is characterized by a flip angle and phase. Spin locking pulses have both an amplitude ₁ and phase.

FIG. 4b: Illustrates a generalized self-compensated pulse sequence for T₂-weighted contrast in the preferred embodiment shown in FIG. 3.

FIG. 5: Illustrates another preferred embodiment where T₂-weighted contrast magnetization Mᵣₚ, characterizing the multiphasic fluid downstream from the edge of the second segment, is spatially encoded and imaged.

FIG. 6: Illustrates another preferred embodiment of the prepolarization segment, in where previously homogeneously mixture multiphasic flow is divided in two branches, each running different path inside the prepolarization segment.

### DETAILED DESCRIPTION OF THE INVENTION

One of the main advantages of Time Domain Magnetic Resonance, hereinafter TD-NMR, is its ability to manipulate material contrast in the NMR signal, just by affecting certain experimental parameters. Those parameters are generally related to relaxation process. It was proven that manipulating parameters related with the Spin-Lattice Relaxation Time (T₁) during the fluid polarization procedure in TD-NMR based multiphasic flow meters it is possible to measure the, for instance, water/oil/gas cuts in production pipes (T. M. Osan, et al. Fast measurements of average flow velocity by Low-Field ¹H NMR, Journal of Magnetic Resonance 209 (2011) 116-122). Contrast between different compounds forming the multiphase fluid is reached by varying the effective longitude of the prepolarization magnetic field (see U.S. Pat. No. 7,719,267, “Apparatus and method for real time and real flow-rates measurements of oil and water cuts from oil production”, by D. J. Pusiol). Protons and/or other NMR active nuclei, forming part of molecules composing any non-metallic material, and in particular a multiphasic fluid, relax majorly by modulation of the spin-spin coupling. Dipolar proton-proton coupling is modulated by molecular dynamics. In other words, the magnetic dipolar energy one can store in the whole sample proton nuclei discharge to the lattice following relaxation mechanisms provided by different molecular motions of molecules in each one of the phases. One special spin-lattice relaxation time, which relaxes the nuclei dipolar energy, is the spin-lattice relaxation time in the rotating frame (T₁). T₁-weighted contrast is primarily obtained by allowing spin-magnetization to relax under the influence of a radiofrequency (RF) pulse. T₁-weighted contrast is in particular sensitive to both low frequency motional processes and static processes. T₁ is known as a powerful method to create contrast in MRI of several materials, like human tissues, free water, organogel phases, liquid crystals, porous media, etc. [see E. Steiner et al., NMR relaxometry: Spin-lattice relaxation times in the laboratory frame versus spin lattice relaxation times in the rotating frame, Chemical Physics Letters, 495 (2010) 287-291].

Measurement and interpretation of NMR relaxation times as a function of the measurement frequency ω₀ (or, equivalently, as a function of the NMR static magnetic field B₀ through the Larmor equation ω₀=γB₀, γ being the gyromagnetic ratio of the considered nucleus) is called Relaxometry (R. Kimmich, NMR—Tomography, Diffusometry, Relaxometry, Springer, Berlin, 1997). Relaxometry dispersion curves—as obtained from the Field Cycling NMR experiments—display the spin lattice relaxation rate as a function of the measurement frequency. However, as far as proton NMR is considered, dispersion curves usually start around 10 kHz and thus miss the very low frequency region. This gap can be filled by the measurement of the spin-lattice relaxation rate in the rotating frame [see E. Steiner et al., NMR relaxometry: Spin-lattice relaxation times in the laboratory frame versus spin lattice relaxation times in the rotating frame, Chemical Physics Letters, 495 (2010) 287-291].

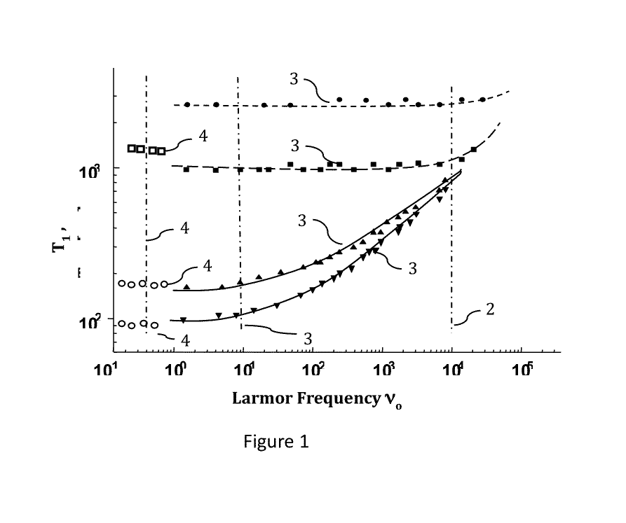

FIG. 1 illustrates on the Larmor frequency behavior of T₁ and T_{1ρ}, respectively. Filled cicles 31 represents the Larmor frequency dependence of the spin-lattice relaxation time, T₁(νₒ), in a methane sample. Filled squares 32 illustrates on T₁(νₒ) behavior in a brine sample. Filled triangles 33 represent the behavior of T₂(νₒ) on a sample of light oil, while a heaviest oil sample is represented by rather small relaxation times 34. Open squares 42 represents measurements of T_{1ρ} (νₒ) in a sample of brine. Same measurements of T_{1ρ} (νₒ) en light oil 43 and heavy oil 44 are also illustrated in FIG. 1. An inspection on said FIG. 1 shows that T₁(νₒ) and T_{1 ρ} (νₒ) dispersion relaxation ratios are experimentally equivalent at Larmor frequency in the kilohertz region. Vertical lines on FIG. 1 represent different technological steps of NMR Flowmeters. Line at higher Larmor frequency 25 is related to U.S. Pat. No. 7,719,267, “Apparatus and method for real time and real flow-rates measurements of oil and water cuts from oil production”, granted to D. J. Pusiol and the U.S. Pat. No. 7,872,474, “Magnetic resonance based apparatus and method to analyze and to measure the bi-directional flow regime in a transport or a production conduit of complex fluids, in real time and real flow-rate”, by D. J. Pusiol, et al. Medium vertical line 35 illustrate on said T₁(νₒ)-dispersion at the lower range of Larmor frequencies, as measured by Field Cycling NMR; as illustrated in said U.S. Provisional Patent Application No. 61/753,819, date 17 Jan. 2013. At said Larmor frequencies range, said contrast between phases of the multiphasic mixture of oil-gas-water, as driven by T₁(νₒ)-dispersion, is several times better than phase contrast at the high-values of Larmor Frequencies. Vertical line 45 illustrate on T_{1ρ} (νₒ)-profiles measurements at Larmor frequencies below 1 kHz. Contrast driven by T₁(νₒ) mechanisms, at least in brine and light and heavy oils behave similarly to those shown in samples measured by Field Cycling NMR. As illustrated in said FIG. 1, measurements of T₁(νₒ) performed by NMR Field Cycling experiments gives equivalent relaxation times as measurements of rotating frame relaxation T_{1ρ} (νₒ). Therefore, it is reasonable to conclude that low Larmor frequencies T₁(νₒ) and rotating frame T_{1ρ} (νₒ) are equivalent mechanisms at the time to produce contrast of phases in the multiphasic fluid vein. The difference between those contrast mechanisms is principally related to differences in the respective experimental set-ups.

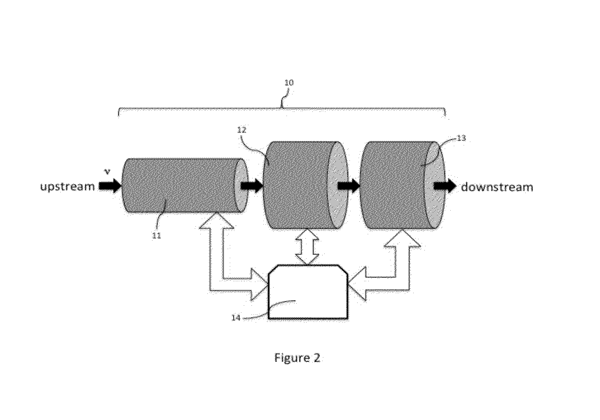

Examples of certain features of the apparatus and method disclosed herein are summarized rather broadly in order that the detailed description thereof that follows may be better understood. There are, of course, additional features of the apparatus and method disclosed herein after that will form the subject of the claims. FIG. 2 illustrate on a schematic multiphasic flow meter/analyzer/control exemplary apparatus 10. From the upstream, it is disclosed a first preparatory magnetization, or prepolarization, segment 11; downstream, a second, contrast segment 12; follows a third NMR-measurement segment 13; and, finally, a fourth segment 14, for evaluation and analysis of the flow regime and physicochemical properties of said multiphasic fluid.

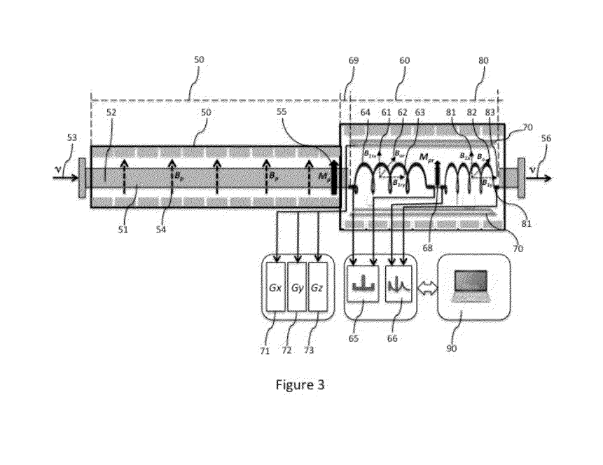

In a first primary embodiment of the present invention, it is disclosed a method and its respective apparatus for multiphasic flow metering. Said embodiment includes in-flow contrast mechanisms, spatial encoding and flow-rate measurements of fluidic phases composing said multiphasic fluid. Flow rates measurements, flow-regime analysis, imaging and physicochemical properties studies methodologies and apparatus, are mainly based on: i) a first pre-polarization magnetic segment, where NMR-active nuclei of molecules conforming each of said phases reach different polarization degrees. Each of said polarization degrees is characterized by their respective laboratory frame spin-lattice relaxation time, T₁, and their time of transit of each phase in that said prepolarization segment; ii) a partial depolarization—or relaxation—second segment, wherein each of said NMR-active nuclei magnetizations relaxes following T₁s. By controlling power, frequency and/or dwell time of said nuclei in said second segment; pluralities of contrast degrees between phases of said multiphasic fluid are reached. After calibration NMR-signals of said phases composes a matrix of contrast degrees, which is further measured in the third segment; iii) a third lowstream segment, wherein NMR signals at different contrast degrees are measured, composing a multidimensional matrix of data containing information of said multiphasic fluid and flow regime; iv) a fourth segment, wherein a processor configured to evaluate flow regime, physicochemical and rheological properties of said multiphasic complex fluid, while said multiphasic fluid is flowing through a vein having arbitrary geometry and mixture states. FIG. 3 schematically illustrates a first exemplary sub-embodiment of the here-disclosed embodiment. Multiphasic fluid 52 enters upstream to the flow meter through the first prepolarization segment 50. Multiphasic fluid 52 flows into a non-magnetic pipe 51 through the magnetic field 54 of said prepolarization segment 50. Longitude and or pipe diameter are fitted in a way that multiphasic fluid velocity 53 in said pipe 51 is enough slow to allow said alignment of multiphasic fluid nuclear spins on Bₚ 54 direction. In the present embodiment, for the whole range of said fluid velocities, the fluid-transit time through the prepolarization segment should be longer than at least five times the longest spin-lattice relaxation time of said components of said multiphasic fluid. At downstream of said prepolarization segment 50, a magnetization Mₚ 55 is created. Following downstream, NMR-active nuclei are passing through a second segment 60, where said nuclei sense a second static magnetic field Bₒᵣ 62 and a third radiofrequency oscillating magnetic field B₁ᵣ 61, 63. Said oscillating magnetic can be linearly polarized in any of the directions x and y, illustrated in the figure as B₁ᵣₓ 61 and B_{1ry} 63, or circularly polarized in the plane x-y. Said oscillating magnetic field 61, 63 have a variable frequency in the range close to said Larmor frequency; a direction following any one perpendicular to said magnetic field 61; and magnitude variable to form any one of the known rotating frame nutation sequences (see, for instance, Slichter, C. P., “Principles of Magnetic Resonance”, Springer-Verlag, 1990, p. 242-246 and Bovey, F. A. and Mirau, P. A., “NMR of Polymers”, Academic Press, 1996, p. 81-83). Combinations of rotating frame and laboratory frame pulse sequences can be also implement in the contrast segment 60. In the intermediate space 69, between said first 50 and second 60 segments, said static magnetic fields Bₒᵣ 62 and Bₚ 54 could change in both, magnitude and/or direction, but the “adiabatic passage” condition (see, A. Abragam, The Principles of Nuclear Magnetism, Clarendon Press, Oxford, 1961) should be fulfilled. In said second segment said nuclei are precessing according to said magnetic field Bₒᵣ 62 at the Larmor frequency ₒᵣ=Bₒᵣ and, simultaneously, are nutating according said radiofrequency field B₁ᵣ 61 and/or 63 with a frequency ω₁ᵣ=γB₁ᵣ. Said process is known as the “spin-lock process”. Within said second segment, nuclear total magnetization 55 is locked by said radiofrequency B₁ᵣ 61, 63. While said multiphasic fluid is flowing through the pipe in said second segment, said magnetization 55 it is decaying—or relaxing—with a plurality of rotating frame spin-lattice relaxation times; each one known as T₁. Generally, a plurality of different phases composing said multiphasic fluid, could imply a similar plurality of different T₁′. Radiofrequency field 61 and/or 63 is created trough a plurality of excitation coils 64, driven by the radiofrequency excitation current, produced in the respective electronic device 65. A third, conventional, NMR segment, at downstream 80, measure the physicochemical properties of said multiphasic fluid and said flow regime properties into said production line. Measurements were previously weighted, in said second segment, by said T₁-relaxation mechanism, during the multiphasic fluid passage trough said second segment of said exemplary flow meter. Several amplitude and timing in B₁ᵣ 61 and 63, adequately correlated with said flow velocities, are used to contrast different materials in the said multiphasic flow. Radiofrequency fields B₁ₓ 81 and B_{1y} 83 and static magnetic field Bₒ 83 are configured in said third segment. Pulsed radiofrequency and data acquisition sequences care implemented in the electronic device 66, designed to measure, in between others, flow rates, physicochemical and rheological properties of sail flowing multiphase fluid. In addition Magnetic Resonance Imaging MRI technology can be added just to know the proportion and/or disposition of fluids into the production pipe. Three axis magnetic field gradients are provided by gradient coils 70, driving by Gₓ 71, G_{y} 72 and G_{z} 73 power electronic supplies. A data matrix is built, including data digitalized from said NMR-signals acquired at said different experimental conditions. In a fourth segment 90 of the multiphasic flow meter a tangible computer-readable medium product having stored thereon instructions that, when read by a processor, enable to execute a calculation method which is designed in base of an exemplary method, which is based in evaluating said data matrix in accordance with:
1. Said spin relaxation properties of each one of said phases composing the multiphasic fluid;
2. The geometrical design of the arrangement of magnets, antennas and fluid paths; the excitation, encoding and detection procedures;
3. A set of independent equations fitting coefficients relating said data matrix elements and experimental variables, as for example, individual phases flow-rate, profile of liquid levels in the pipe, in-pipe localized viscosity measurements, in-pipe density profile of fluids, size distribution of solid particles and others.
4. A set of calibration curves previously measured in a multiphasic flow loop.

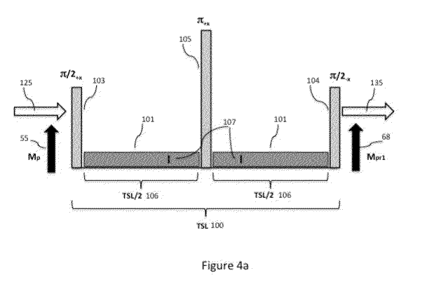

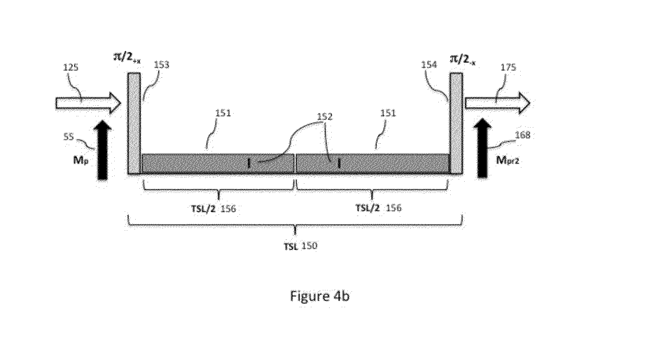

Artifacts in T_{1ρ} produced by B₁ᵣ and Bₒᵣ imperfections can be compensated by a more elaborated magnetic field sequences sensed by the fluid during it passage through the second segment (see W. R. T. Witschey II, et al., Artifact in T₁ imaging: Compensation for B₁ and Bₒ field imperfections, J. Magn. Resonance, 186 (2007) 75-85). Using the Bloch equations can be analyzed the origin of B₀ and B₁ spin locking artifacts. Multiphasic fluid protons, when are introduced to said second—rotation frame longitudinal relaxation—the pulse sequence illustrated in FIG. 4a, which significantly corrects for those artifacts. Multiphasic fluid 125, flowing from said—prepolarization—first segment 50, possessing a magnetization Mₚ 55, enters in said relaxation second segment 60, where said compensated-longitudinal rotating frame relaxation excitation 100 is applied. The spin-lock pulse is divided into several segments with alternating phase and equal durations (“self-compensating”). A first hard 90° radiofrequency pulse 103 is applied in the +x direction; following, a first half of said spin-lock radiofrequency pulse 101 of duration 106 and intensity | 107 is applied in the direction +x. In the middle of the sequence a hard 180° hard pulse 105 is applied. Then, follows the second half 102 of said spin-lock radiofrequency pulse 102 of duration 106 and intensity | 107, applied in the direction −x. Finally, the sequence close with the last 90° +x radiofrequency hard pulse. At the end of said second segment, each component of said multiphasic fluid contributes differently to the final—partially relaxed—magnetization Mₚᵣ 68. A strong crusher gradient, not illustrated, is applied to destroy any residual magnetization in the transverse plane.

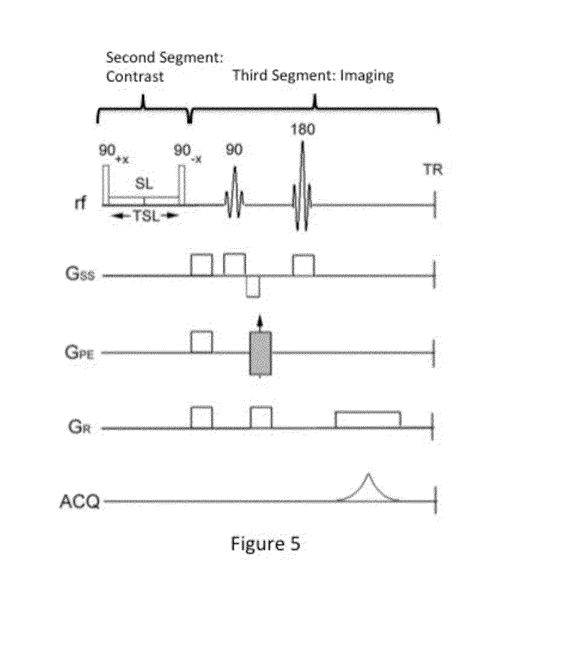

In a second exemplary sub-embodiment of the first primary embodiment of the present invention, the fluid is first homogeneously mixtured inside the pipe and it is then divided in two flowing paths. FIG. 5 illustrate on one of the preferred pre-polarization sub-embodiment. Said multiphasic flow 201 is divided, respectively, in two: i) in a straight pipe 203 and ii) in a helicoidally surrounded second pipe 202. Said two portions are flowing at different flow rates, therefore said NMR-active spins are polarized in said first segment 50 of said multiphasic flow meter at different degrees. The staying time of both portions of said fluid inside the prepolarization magnetic field region 50 are respectively different. Molecules of said fluid flowing through say both pathways are then relaxed in said second downstream segment and measured in said following third segment of the multiphase flow meter. Said computing device in said fourth segment is programmed to evaluate said actual data matrix on the basis of said above-mentioned method. There are other geometrical configurations that fulfill the condition of divide said upstream flow in a plurality of flows each reaching different polarization degrees.

In a third exemplary sub-embodiment of the first primary embodiment of the present invention, a combination of both, part of said multiphasic fluid pass through the prepolarization magnetic field at a determined passage time, to reach a partial pre-polarization degree, and a second part pass through a conduit at a different velocity just to reach a different partial or full passage velocity. Two portions of the multiphasic are flowing at different velocities and flow rates, therefore said N MR-active spins are polarized in said first segment of said multiphasic flow meter at different—but controlled—degrees, just because the staying time of both portions of the fluid are respectively different. Molecules of said fluid flowing through say both pathways are then relaxed in said second downstream segment and measured separately in said following third segment of the multiphase flow meter. Cuts and molecular compositions of flow branches, each having different degrees of polarizations, are now encoded in the velocity measurements. Said computing device in said fourth segment is programmed to evaluate said actual data matrix on the basis of said above-mentioned method.

In a second primary embodiment of the present invention, contrast between different materials in the multiphasic fluid is T₂-weighting. The T₂ parameter describes the relaxation of the transverse magnetization in the rotating frame, which occurs under the influence of a radiofrequency spin-lock pulse. FIG. 4b illustrate on the radiofrequency pulse sequence, which is applied to multiphasic fluid molecules during its passage through the second-relaxation segment. During the application of said spin-lock pulse, TSL 151, the signal decays exponentially according to the decay constant T₂. T₂-weighting can be added to nearly any pulse sequence using a spin-lock radiofrequency pulse cluster. In the spin-lock pulse cluster, a nonselective 90° rf pulse 153 is first applied along the +x axis to nutate the longitudinal magnetization into the transverse plane along the +y axis. A spin-lock pulse TSL 151 and intensity | 152 is immediately applied along the +x axis to be orthogonal to the nutated magnetization vector. During the first half of the duration of the spin-lock pulse TSL/2 156, in the rotating frame of reference the magnetization nutates in the positive direction about the y-z plane and relaxes according to both T₁ and T₂ processes. The rate of exponential decay during this time is described by the T₂ parameter. Halfway through the TSL 151 pulse, the phase of the spin-lock pulse is flipped by 180° to nutate the magnetization vector back onto the +y axis during the remaining period of TSL/2 hence forming a rotary echo. At the end of the spin-lock pulse, a second 90° rf pulse along the −x axis is applied to nutate the T₂-prepared magnetization back into the longitudinal axis where it is subsequently excited, measured and/or imaged Because both T₁ and T₂ relaxation processes occur while in the rotating frame, for small spin-lock pulse amplitudes much less than the Larmor frequency (B₁/2 on the order of kilohertz) and assuming that the predominant source of T₂ relaxation comes from dipolar contributions, 1/T₂ can be described as the average of the reciprocals of T₁ and T₂ (see Kelly S. W., Sholl C. A. “A relationship between nuclear spin relaxation in the laboratory and rotating frames for dipolar and quadrupolar relaxation”, J. Phys. Condens. Matter; 4 (1992) 3317-3330):

1/T₂ ½(1/T₁+1/T₂),

For many complex fluids, T₁>>T₂ and therefore T₂ is close to twice T₂. In practice, inhomogeneity of B₀ and B₁ and the effects of diffusion and exchange processes make the effective T₂ shorter thereby resulting in an experimental measurement of T₂ that is less than twice T₂. Because T₂ predominantly affects T₂, a T₂-weighted measurement will yield T₂-like contrast. Given that T₂ is always greater than T₂, the signal-to-noise ratio (SNR) of a T₂-weighted NMR signal is greater than a T₂-weighted NMR signal for the same contrast evolution duration (TSL in the case of T₂ or TE in the case of T₂).

T₂ is not to be confused with the related spin-lock contrast mechanism T₁, which represents the spin-lattice relaxation in the rotating frame during a spin-lock pulse. T₁-weighting can be applied using the same spin-lock pulse cluster used to impart T₂-weighting with the important distinction that the phase of the spin-lock pulse of the T₁-weighting spin-lock pulse is set so that the spin-lock pulse is applied parallel to the magnetization vector rather than orthogonal. T₁-weighting is different than T₂ weighting in that, like T₁, T₁ exhibits dispersion as a function of B₁/2, whereas T₂ is weakly affected by B₁/2. With B₁/2 near zero, T₁˜T₂ and as B₁/2 increases, T₁ increases toward a maximum of T₁. The T₁ parameter has been shown to be sensitive to molecular processes occurring in the range of frequencies near B₁/2 and therefore T₁ has been used as mechanism to generate contrast based on macromolecular content.

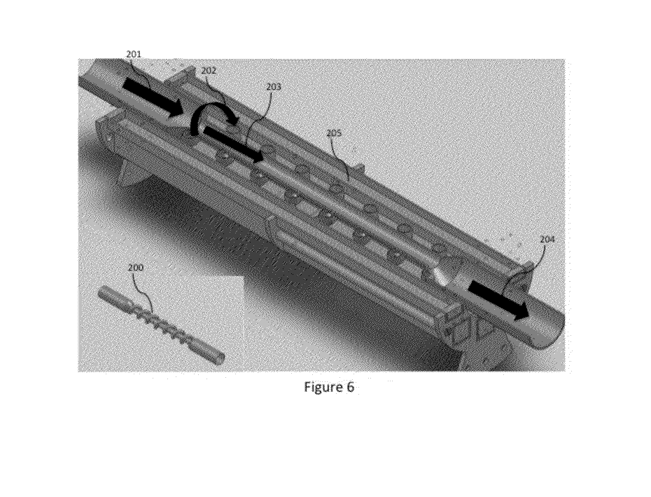

An example NMR flow meter/controller 10 is shown in FIGS. 2-6 to illustrate NMR instrumentation techniques and apparatus improvements that alone and/or in combination can improve, reduce costs, and make NMR instrumentation and analytical capabilities more available, convenient, and cost effective for a variety of fluid applications. Therefore, while most of the description herein utilizes the example flow meter 10 as a convenient vehicle to explain the features, apparatus, and methods claimed herein, these features, apparatus, and methods are not intended to be limited to this example or to only flow meters or flow controllers. On the contrary, NMR signal generation and detection using any one or more of the features or processes described herein are useful for myriad other NMR instrumentation and analytical applications as well. Also, the illustrations in the drawings are not drawn to illustrate any particular sizes or proportions, and while some such sizes or proportions may be exaggerated or distorted for practicality, persons skilled in the art will understand the information illustrated.

Where it is declared or described that an apparatus of this invention includes, contains, has, is compound or is constituted by certain components, it must be understood, except when this declaration or description expresses the contrary, that one or more explicitly described components can be present in the apparatus. In an alternative embodiment, nevertheless, the apparatus of this invention can essentially be declared or described as consisting of certain components, in which the components of this embodiment which could materially alter the operation principle or the differentiating characteristics of the apparatus could not be present in the declaration or the description of this alternative embodiment. In another alternative embodiment, the apparatus of this invention can be declared or described as consisting of certain components, in which other components of the embodiment could not be declared or described.

Where the article “a” is used in a declaration of or in a description of the presence of a component in the apparatus of this invention, it must be understood, unless this declaration or description expresses explicitly the contrary, that the use of the indefinite article does not limit the presence of the component in the apparatus to one in number.

As also mentioned above, in addition to the flow metering and controlling applications, the apparatus and methods described herein also have other NMR analytical applications for fluids. Three major approaches in which the apparatus and methods described herein are useful include: (i) NMR signal intensity; (ii) spin-lattice relaxation time T₁; (iii) spin-lattice relaxation time in the rotating frame T₁; (iv) spin-spin relaxation time T₂; and (v) spin-spin relaxation time T₂. Some example analytical applications in which one or more of the methods and apparatus described herein are useful, either alone or in combination with other instrumentations and measurements (e.g., temperature, etc.), may include: ortho concentration in liquid hydrogen, oxygen concentration in water, oxygen concentration in organic solvents, discrimination of mesophases in liquid crystals, concentration of metal ions in water, solids content and solid surface area of slurries, fat content of oil/water emulsions, quality of cooking oil, solids content of black liquor, and many others.

The words “comprise,” “comprises,” “comprising,” “composed,” “composes”, “composing,” “include,” “including,” and “includes” when used in this specification, including the claims, are intended to specify the presence of state features, integers, components, or steps, but they do not preclude the presence or addition of one or more other features, integers, components, steps, or groups thereof. Also the words “maximize” and “minimize” as used herein include increasing toward or approaching a maximum and reducing toward or approaching a minimum, respectively, even if not all the way to an absolute possible maximum or to an absolute possible minimum. The term “insignificant” means not enough to make a difference in practical applications, unless the context indicates otherwise. Also, the measurements described can be repeated any number of times by allowing enough time between measurements for the fluid affected by the RF field to clear out of the coil volume 81 and then performing the measurements again. Multiple measurements can be used, if desired, to determine flow rate or rates, average flow rates, statistical flow rates, etc. Also, while the methods described above referred to NMR measurements utilizing the spins or nuclear magnetic moments of hydrogen, these NMR measurements can also be made with nuclear magnetic moments of fluorine, chlorine, and other materials.

Examples of certain features of the apparatus and method disclosed herein are summarized rather broadly in order that the detailed description thereof that follows may be better understood. There are, of course, additional features of the apparatus and method disclosed herein after that will form the subject of the claims:
1. At said prepolarization segment, the whole set of NMR-active spins are polarized by passing through a magnetic field. During said passage, nuclear spins belonging to molecules of individual phases in said multiphasic fluid, reach different degrees of polarization. As exemplary embodiments, said different polarization degrees can be reached through different processes:
   1.1. In a first exemplary embodiment, full polarization of said multiphasic fluid by regulating the passage time to be longer than at least five times the longest spin-lattice relaxation time of said molecules forming said multiphasic fluid. Just the second—rotating frame relaxation—segment produce the contrast between molecular components of said phases.
   1.2. In a second exemplary embodiment, partially polarized phased can be reached by fitting the longitude of the prepolarization segment below the necessary to reach a full polarization of all phases.
   1.3. In a second exemplary embodiment, said multiphasic fluid, after a previous mixing by mechanical, is divided in a plurality of branches; each running at the same velocity, but trough different paths, inside the site of prepolarization magnet. Consequently, each one of said phases can reach different polarization degrees.
   1.4. In a third exemplary embodiment, it is disclosed a variant where part of said multiphasic fluid pass through the prepolarization magnetic field at a determined passage velocity to reach a partial prepolarization degree, and a second part pass through a conduit at a different velocity just to reach a different partial or full passage velocity. In another preferred embodiment a plurality of said conduits are implemented in said prepolarization segment. Downstream, in said third relaxation segment, relative concentration of said homogeneous mixture of phases are encoded by its velocities and measured in the third segment.
2. At said relaxation segment, said NMR magnetization provided by nuclei of molecules of the phases mixture of said multiphasic fluid are contrasted by weighting said N MR-signals through pluralities of laboratory and/or rotating frame relaxation procedures. said rotating frame relaxation processes. At said relaxation (or contrast) segment, are implemented:
   2.1. In a first exemplary embodiment, by an on-resonance radiofrequency irradiation pulse sequence, including Bₒ and B₁ respective inhomogeneity compensation.
   2.2. In a second exemplary embodiment, by an off-resonance radiofrequency irradiation pulse sequence, including Bₒ and B₁ respective inhomogeneity compensation.
   2.3. In a third combination of a plurality of said first field cycling and a plurality of said rotation frame relaxation-contrast procedures.
3. Said contrasted phases velocity profile is measured in the NMR measurement segment of said flow meter by measuring the time of flight of said contrasted phases in the NMR excitation/detection antenna. A multidimensional data matrix is build; including NMR signal measurement in both laboratory and rotating frames. In the said third step spins of the sample are subjected to radiofrequency and magnetic field gradients in steady state or in pulsed sequences designed ad-hoc for each measurement.
   3.1. In a first exemplary embodiment said data matrix elements are recorded in the Fourier domain.
   3.2. In a second exemplary embodiment said data matrix elements are recorded in the Time Domain (Laplace domain).
   3.3. In a third exemplary embodiment said data matrix elements are, in addition, spin density spatially encoded and spin velocity encoded at several degrees of contrasts between phases of said multiphasic fluid, following procedures of Magnetic Resonance Imaging in the Fourier domain.
   3.4. In a fourth exemplary embodiment said data matrix elements are, in addition, spin density spatially encoded and spin velocity encoded at several degrees of contrasts between phases composing said multiphasic fluid, following procedures of Magnetic Resonance Imaging in the rotating frame domain.
   3.5. In a fifth exemplary embodiment said data matrix elements are, in addition, spin density spatially encoded and spin velocity encoded at several degrees of contrasts between phases composing said multiphasic phases, following combined procedures of said Magnetic Resonance in, respectively, said Fourier and said Laplace domains.
   3.6. In a fifth exemplary embodiment said data matrix elements are recorded by in-line measurements of said contrasted multiphasic fluid rheological properties like, but not solely, parallel and perpendicular to the flow viscosities by passing the fluid through a helical path into the NMR antennas set during the measurement procedure.
   3.7. In a seventh exemplary embodiment said data matrix elements are recorded by in-line measurements of said contrasted multiphasic fluid Magnetic Resonance Fourier Spectrometry, Time Domain Relaxometry and/or Diffusometry parameters.
   3.8. A preferred exemplary embodiment for a triphasic fluid:
      3.8.1. Fully polarize said NMR-active nuclei in the first pre-polarizing segment, where the maximum molecules of said multiphasic fluid stay into said segment at least five times the maximum spin-lattice relaxation time of said phases.
      3.8.2. Pass said pre-polarized fluid through said second segment and selects a first degree of contrast to obtain a first row of elements in the data matrix, by controlling the frequency and duration of the relaxation period in the rotating frame.
      3.8.3. Obtain a first average velocity and cut measurement for a first degree of contrast, from said NMR signals received from said multiphasic fluid, in response to said first NMR excitations sequence;
      3.8.4. Wait the period of passage of the measured portion of said first volume or apply a spoiler magnetic field gradient pulse.
      3.8.5. Repeat steps 3.8.3 and 3.8.4 until reach a reasonable signal to noise ratio.
      3.8.6. Repeat steps 3.8.2 to 3.8.4 until complete the set of measurements necessary to complete the set of said data matrix.
      3.8.7. Estimate said phase-velocities and said phase proportions from data matrix, using—if apply—the condition that the total useful volume inside fluid vein is occupied by said multiphasic fluid.
      3.8.8. Estimate said flow rate of said fluid-phases, using the estimated velocity of said phases and estimated mass fractions of said phases.
4. Another embodiment of the present disclosure is a tangible computer-readable medium product having stored thereon instructions that when read by a processor enable the processor to execute a method. The method is based in evaluating said data matrix in accordance with:
   4.1. Said spin relaxation properties of each one of said phases composing the multiphasic fluid;
   4.2. The geometrical design of the arrangement of magnets, antennas and fluid paths; the excitation, encoding and detection procedures;
   4.3. A set of independent equations fitting coefficients relating said data matrix elements and experimental variables, as for example, individual phases flow-rate, profile of liquid levels in the pipe, in-pipe localized viscosity measurements, in-pipe density profile of fluids, size distribution of solid particles and others.
   4.4. A set of calibration curves.

In a second aspect, the present disclosure provides an apparatus for estimating a flow rate of a phase of a multiphase fluid. An exemplary apparatus includes:
1. a prepolarization magnet, configured to fully polarize the NMR-sensible nuclei belonging to molecules of the total of said phases of the said multiphasic fluid;
2. a radiofrequency transmitter configured to provide NMR-excitations to said multiphasic fluid in a plurality of stages along the production vein; being producing, in addition, the radiofrequency field to create said rotating frame relaxation in said second contrast segment
3. a pulsed conventional transmitter/receiving configured to obtain NMR-response signals from said multiphasic-fluid, in response to the NMR excitations; and
4. a processor configured to evaluate flow regime, physicochemical and rheological properties of a multiphasic complex fluid, while said multiphasic fluid is flowing through a vein having arbitrary geometry and mixture states. In one preferred embodiment, calculation mathematical algorithms are implemented in said processor in order to evaluate said data matrix.

In a further aspect, the present invention provides a method of magnetic resonance in the rotating frame to evaluate flow regime, physico-chemical and rheological properties of a multiphasic complex fluid, while said multiphasic fluid is flowing through a vein having arbitrary geometry and mixture states characterized by within said third segment say nuclear spins of the flowing multiphasic fluid is subjected to radiofrequency and magnetic field gradients in steady state or in pulsed sequences designed ad-hoc for each measurement. Those magnetic resonance parameters are cyclically measured at several values of contrasts, in such a way that the sample relaxation in the rotating frame and/or diffusion profiles can be scanned and storage in a mathematical multidimensional data matrix.

In a further aspect, the present invention provides a method of magnetic resonance in the rotating frame to evaluate flow regime, physico-chemical and rheological properties of a multiphasic complex fluid, while said multiphasic fluid is flowing through a vein having arbitrary geometry and mixture states characterized by the invention provides a method of magnetic resonance in the rotating frame to evaluate said composition of the multiphase fluid and said relative velocities of the phases a multiphasic fluid flowing through a pipe where said method comprising: a) providing a static magnetic field BO along a first direction; b) Fourier encoding nuclear spins in a sample by applying a rotating-frame field gradient BG, superimposed on the B0 field, wherein the BG field comprises a vector component rotating in a plane perpendicular to the first direction at an angular frequency w in a laboratory frame; and c) detecting a Fourier encoded NMR signal.

According to a further aspect, the invention also discloses measurements of NMR Parameters, NMRP, which are any numerical data, electromagnetic or mechanical effects, or images provided by frequency-domain NMR and/or EPR, time-domain NMR and/or EPR and/or MRI of fluids subjected to relaxation and/or spatial encoding in the rotating frame. NMRP can be related to microscopic and/or macroscopic physicochemical, rheological and/or (weighted or not by diffusion, relaxation and/or other signal weighting procedures) MRI of the studied individual-phase and/or bulk multiphasic fluid.

According to a further aspect, the invention provides a range of Multiphasic Fluids to be studied, being composed by any mixtures of solids, liquids, gases, emulsions, foams and/or powdered solids. The mixtures can be homogeneous or not. Those non-homogeneous single or mixture materials are included at any sizes of drops and or grains, even those at nanometric scales as well.

According to a further aspect, the present invention provides method to in-pipe image flowing multiphase fluid densities, weighted by said spin relaxation in the rotating frame phenomena of, previously polarized, spins during their passage through the contrast segment.

According to a further aspect, the present invention provides method to measure in-pipe localized velocity profiles of said multiphasic fluid, weighted by said spin relaxation in the rotating frame phenomena of, previously polarized, spins during their passage through the contrast segment.

In another aspect, the present invention provides a method of magnetic resonance in the rotating frame to evaluate flow regime, physico-chemical and rheological properties of a multiphasic complex fluid, while said multiphasic fluid is flowing through a vein having arbitrary geometry and mixture states, characterized by electric excitation and/or detection of nuclear and/or magnetic spins moments as well. Measurements are performed in a “Region of Interest”, ROI, which is the volume of fluid in which sets of N MR-parameters are measured during the rotating frame nutation takes place. One or more ROI could be localized in regions of the fluid vein, where both static and variable magnetic fields are applied, and presents properties of local time stability, homogeneity, linearity and/or localization, compatible with NMR experiments. Generally, neither but nor exhaustively, at least one ROI is localized in the detection section multiphase flow meter-apparatus.

In another aspect, the present invention provides a method of magnetic resonance in the rotating frame to evaluate flow regime, physico-chemical and rheological properties of a multiphasic complex fluid, while said multiphasic fluid is flowing through a vein having arbitrary geometry and mixture states are characterized through measurement of relaxation profiles of the fluid weighted by the spin relaxation in the rotating frame of multiphasic NMR active-spins, previously polarized, during their passage through the contrast segment. Those measurements can be related to macroscopic fluid parameters like, for instance, but not solely, viscosity, water salinity, heavy and light oil characterization.

Another preferred embodiment of the present invention is the measurement of rheological properties, like, but not solely, parallel and perpendicular to the flow viscosities by passing the fluid through a helical path into de NMR coils set during the measurement procedure.

Another preferred embodiment of the present invention is the double resonance measurement by putting in thermal contact different spins sets from nuclei and/or electrons coupled by both magnetic and/or electric Hamiltonians.

The invention claimed is:

1) A method to measure flow properties, including flow rates, regime and relative concentrations of phases in multiphasic fluids using Nuclear Magnetic Resonance Relaxation in the Rotating Frame, comprising:
a. polarizing a plurality of Nuclear Magnetic Resonance active spins of a multiphasic fluid using a first magnetic field region, wherein the multiphasic fluid is composed by a plurality of phases, wherein the multiphasic fluid is herein flowing through the first magnetic field region, therefore creating a total macroscopic magnetization of the multiphasic complex fluid, wherein the total macroscopic magnetization is the result of adding all of a plurality of individual macroscopic magnetizations, each corresponding to the different phases of the multiphasic complex fluid;
b. relaxing the plurality of individual macroscopic magnetizations of the phases of the multiphasic fluid in a first Nuclear Magnetic Resonance segment, wherein a plurality of radiofrequency pulses is applied to the multiphasic fluid, wherein the plurality of individual macroscopic magnetizations of the phases of the multiphasic fluid are relaxing in the rotating-frame condition, wherein the multiphasic fluid is herein flowing through the first Nuclear Magnetic Resonance segment, having a downstream end, wherein each macroscopic magnetization of each individual phase of the multiphasic complex fluid relaxes with different rotating frame relaxation rates, wherein applying the plurality of radiofrequency pulse sequences produce that the individual macroscopic magnetization of each phase of the multiphasic fluid at the downstream end of the second magnetic field region is, therefore applying the plurality of pulse sequences will encode an individual magnetization value for each of the phases in the total macroscopic magnetization for each of pulse sequences applied, wherein a degrees of contrast between phases are reached for each said radiofrequency pulse sequences;
c. measuring the total macroscopic magnetization and fluid velocity for each of the rotating frame pulse sequences applied in a second Nuclear Magnetic Resonance segment, comprising a Nuclear Magnetic Resonance measurement module, wherein the Nuclear Magnetic Resonance measurement module permits measuring a plurality of magnetic resonance experimental parameters, wherein the Nuclear Magnetic Resonance measurement module is capable of acquiring a plurality of Nuclear Magnetic Resonance signals corresponding to the Nuclear Magnetic Resonance active spins of the multiphasic complex fluid, therefore multiphasic flow properties, weighted by the rotating frame relaxation profile and additional diffusion profile, are acquired and stored in a multidimensional data matrix;
d. reading the multidimensional data matrix with a tangible computer-readable medium having stored thereon instructions that when read by a processor enable the processor to execute a method to evaluate multiphasic flow properties, weighted by rotating frame relaxation mechanism and diffusion profile.

2) The method according to claim 1, wherein the method of step (d) further comprises evaluating the data matrix in accordance with spin relaxation properties of each one of the phases composing the multiphasic complex fluid, evaluating geometrical design of arrangement of magnets, antennas and fluid paths, evaluating a set of calibration matrix; evaluating excitation, encoding and detection procedures, evaluating a plurality of independent equations fitting coefficients relating to the data matrix, the data matrix comprising individual phases flow-rate.

3) The method according to claim 2, wherein the method of step (d) of claim 1 further comprises, evaluating profile of liquid levels in the pipe.

4) The method according to claim 2, wherein the method of step (d) of claim 1 further comprises, and evaluating in-pipe localized viscosity measurements .

5) The method according to claim 2, wherein the method of step (d) of claim 1 further comprises, in-pipe density profile of fluids.

6) The method according to claim 2, wherein the method of step (d) of claim 1 further comprises size distribution of solid particles.

7) An apparatus to measure flow properties, including flow rates, regime and relative concentrations of phases in multiphasic fluids using Nuclear Magnetic Resonance Relaxation in the Rotating Frame, comprising:
a first magnet module, wherein the magnet module having an upstream end and a downstream end, the first module comprising a first magnet, wherein the first magnet creates a first magnetic field region with a constant magnetic field intensity, wherein the multiphasic fluid flows through said first magnetic field region, and wherein in the first magnetic field region a plurality of Nuclear Magnetic Resonance active spins of the multiphasic fluid are polarized;
a second magnet region having an upstream end and a downstream end, the second region, comprising a magnetic resonance in the rotating frame segment, wherein the upstream end of the second segment is adjacently connected to the downstream end of the first region the multiphasic complex fluid flows to the second magnet module, wherein the second magnet creates a second magnetic field region, wherein the a plurality of radiofrequency antennas are irradiating with variable intensity and time, and wherein the fluid passes through said magnetic resonance in the rotating frame segment, and wherein a plurality of radiofrequency pulses sequences are irradiating said plurality of spins of the multiphasic fluid are relaxing in the rotating frame, wherein degrees of contrast between magnetization corresponding to each phase of the multiphasic fluid;
an third module, having an upstream end and a downstream end, wherein the third module comprising a third magnet, a plurality of radio-frequency antennas and a plurality of magnetic field gradient coils, wherein the upstream end of the third segment is adjacently connected to the downstream end of the second magnetic region; wherein the third magnet creates a third magnetic field region with a constant magnetic field intensity, wherein the fluid passes through the third magnetic field region, wherein the radio-frequency antennas create an electromagnetic excitation field applying a plurality of radio frequency pulses, wherein the fluid passes through the electromagnetic excitation field, and wherein the radio-frequency antenna receives a magnetic resonance signal response originated in the multiphasic complex fluid; wherein the magnetic field gradient coils create a plurality of variable local magnetic fields, wherein the fluid passes through the plurality of variable local magnetic fields, wherein the plurality of spins of the multiphasic complex fluid are spatially encoded;
a fourth module, the fourth module comprising a computing digital processor, configured to read a tangible computer-readable medium having stored thereon instructions that when read by a processor enable the processor to execute said method and additionally control said NMR rotating frame flow meter apparatus, to execute automatic experimental measurements and display experimental results.

8) The apparatus of claim 7, wherein the first magnet module has a size that is large enough so the passage time of the multiphasic complex fluid through the first magnet module is longer than five times the longest spin-lattice in the laboratory frame relaxation time of the NMR active spins forming the multiphasic complex fluid, wherein at the downstream end of the first magnet module the NMR active spins of each phase composing said multiphasic complex fluid are, respectively, weighted by their respective Hydrogen Index.
